(19) United States
(12) Patent Application Publication
(10) Pub. No.: US 2008/0312569 A1
(43) Pub. Date: Dec. 18, 2008

(54) Kneading mechanism for use in a massage device of a massage machine

(76) Inventor: Ko-Po Chen, Ta-Li City (TW)

Correspondence Address: PRO-TECHTOR INTERNATIONAL SERVICES, 20775 NORADA CT., SARATOGA, CA, 95070, US

(21) Appl. No.: 11/818,378

(22) Filed: Jun. 14, 2007

(51) Int. Cl. A61H 7/00

(52) U.S. Cl. 601/134

(57) ABSTRACT

A kneading mechanism for use in a massage device of a massage machine comprises a rubbing mechanism including two sets of upper and lower swing plates having upper and lower massage rollers, wherein a kneading mechanism may drive a kneading stem by way of a motor and a pulley set, and the kneading stem includes a crank and connecting rod assembly axially disposed at each of two ends thereof, and a connecting rod of the crank and connecting rod assembly is axially coupled to the lower swing plate, thereby the lower swing plate may be easily controlled to actuate the operation and multiple-section positions of the lower massage roller, for obtaining different rubbing and kneading massage positions and forces.

### BACKGROUND OF THE INVENTION

1. Field of the Invention

The present invention relates to a kneading mechanism for use in a massage device of a massage machine that may adjust the distance of the upper and lower massage rollers for obtaining different rubbing and kneading positions and forces.

2. Description of the Prior Arts

Referring to FIGS. 1-2, TW Pat. No. 94107217 to Chen discloses “Massaging Device of Massaging Machine” including a rubbing mechanism 1 and a kneading mechanism 2, wherein the rubbing mechanism 1 includes a motor 11 for driving the rotation of a rubbing shaft 12, the rubbing shaft 12 includes an outwardly eccentric rubbing sleeve 13 axially disposed at each of two ends thereof and having a swing arm 14 mounted in the exterior thereof for pivotally connecting with a set of upper and lower swing plates 15, 16, on which upper and lower massage rollers 17 and 18 are attached, and the kneading mechanism 2 includes action pieces 21 and 22 respectively secured on the swing arm 14 and the lower swing plate 16, and between the action pieces 21 and 22 is provided with an air bag 23 controlled by an inflator to inflate or deflate air, and between the top surfaces of the action pieces 21 and 22 is defined with a spring 25 for auxiliarily returning the action piece 22. During a rubbing massage, the motor 11 is controlled to urge the rotation of the rubbing shaft 12 so as to actuate the swing arm 14 and the upper and lower swing plates 15, 16 to operate by means of the rubbing sleeve 13, such that the upper and lower massage rollers 17 and 18 cause a smooth distance change for rubbing user's back. As shown in FIG. 2, during the kneading massage, the upper massage roller 17 places on user's shoulder, and the inflator 24 introduces air into the air bag 23 to result in inflation for pushing the action pieces 21, 22. Since the action piece 21 is fixed, while another action piece 22 is urged by the air bag 23 to swing downward and to pull the spring 25, causing an upper swing of the massage roller 18 so as to cooperate with the upper massage roller 17, and to knead the muscle of user's shoulder. After releasing air from the air bag 23, the action piece 22 returns upwardly by using the spring 25 and the lower massage roller 18 swings downwardly to ease the muscle of user's shoulder so as to apply the lower swing plate 16 to urge the lower massage roller 18 for having a kneading massage.

However, as shown in FIGS. 1 and 3, because the swing angle influences the rubbing position and force of the rubbing mechanism 1, for example, as the massage roller 18 swings closely to the upper massage roller 17, resulting in a change of rubbing position. Furthermore, because the inflating amount of the air bag 23 is not easy to control, failing to quickly adjust the inflation of the air bag 23 for controlling the action piece 22 to actuate the lower massage roller 18 to swing toward the required angle, thus unabling to control the swing position in a multiple angle manner.

The present invention has arisen to mitigate and/or obviate the afore-described disadvantages.

### SUMMARY OF THE INVENTION

The primary object of the present invention is to provide a kneading mechanism for use in a massage device of a massage machine that comprises a rubbing mechanism including two sets of upper and lower swing plates having upper and lower massage rollers, wherein a kneading mechanism may drive a kneading stem by way of a motor and a pulley set, and the kneading stem includes a crank and connecting rod assembly axially disposed at each of two ends thereof, and a connecting rod of the crank and connecting rod assembly is axially coupled to the lower swing plate, thereby the lower swing plate may be easily controlled to actuate the operation and multiple-section positions of the lower massage roller, for obtaining different rubbing and kneading positions and forces.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram of a kneading mechanism of TW Patent No. 94107217;

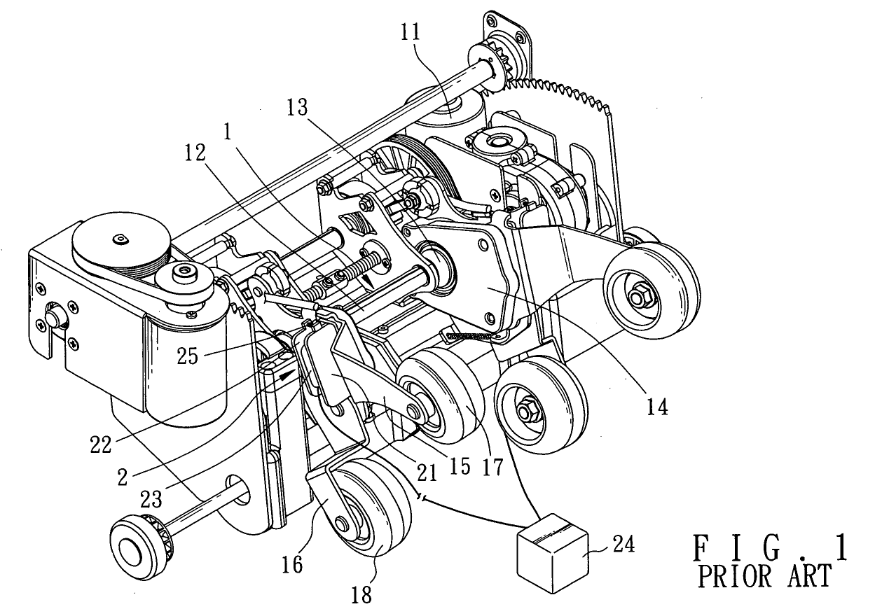

FIG. 2 is an operational plane diagram of the prior art kneading mechanism;

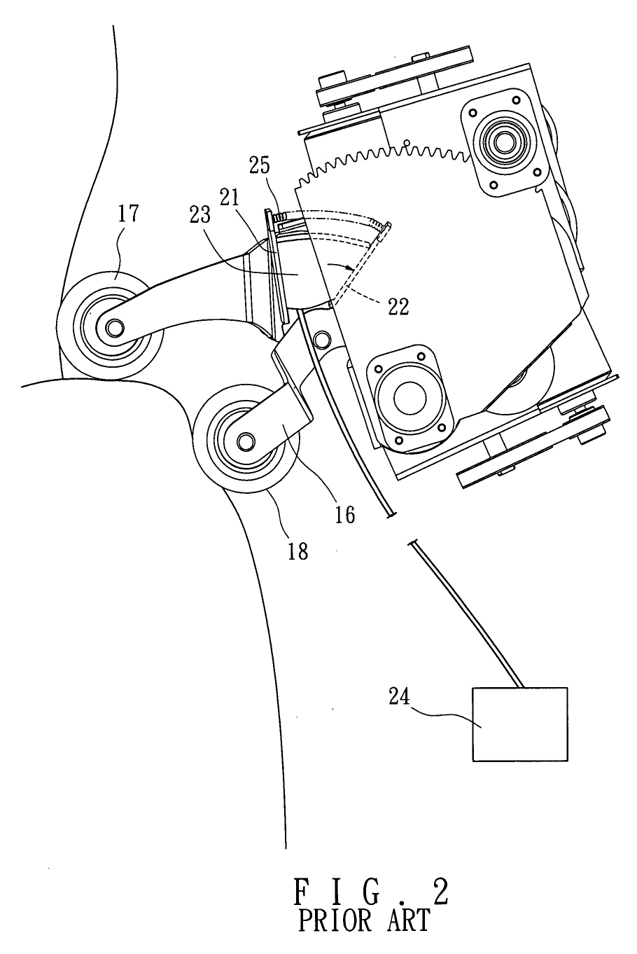

FIG. 3 is an operational plane diagram of a lower massage roller of the prior art kneading mechanism

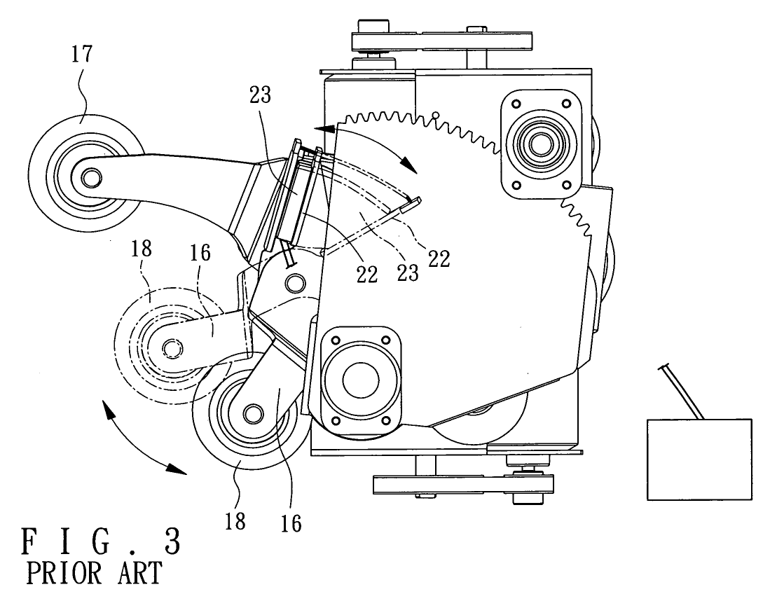

FIG. 4 is a perspective diagram of the kneading mechanism according to the present invention;

FIG. 5 is another perspective diagram of the kneading mechanism according to the present invention;

FIG. 6 is a side plane diagram of the kneading mechanism according to the present invention;

FIG. 7 is an operational diagram of the kneading mechanism according to the present invention;

FIG. 8 is a further operational diagram of the kneading mechanism according to the present invention;

FIG. 9 is another operational diagram of the kneading mechanism according to the present invention;

FIG. 10 is another operational diagram of the kneading mechanism according to the present invention.

### DETAILED DESCRIPTION OF THE PREFERRED EMBODIMENT

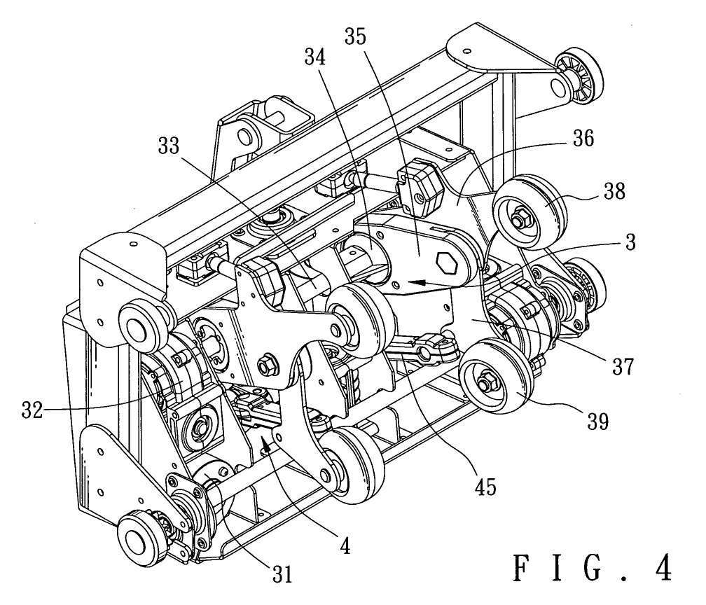

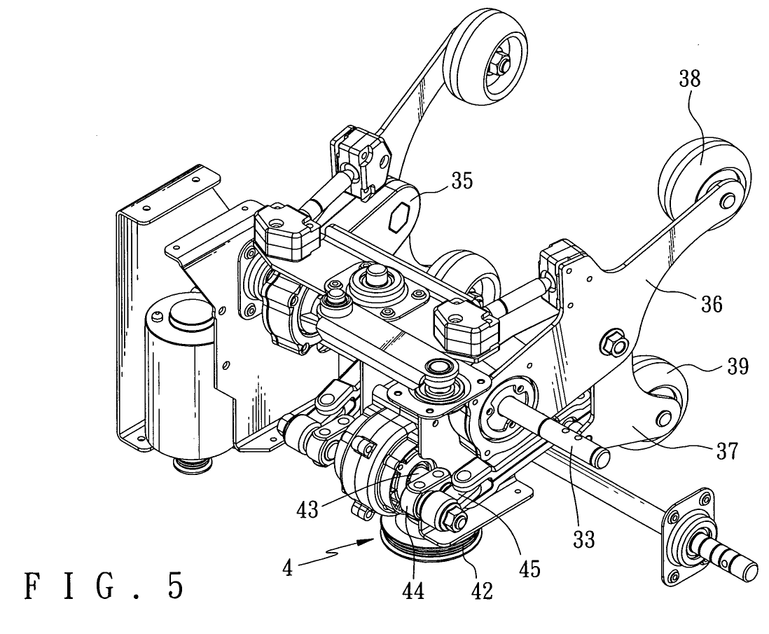

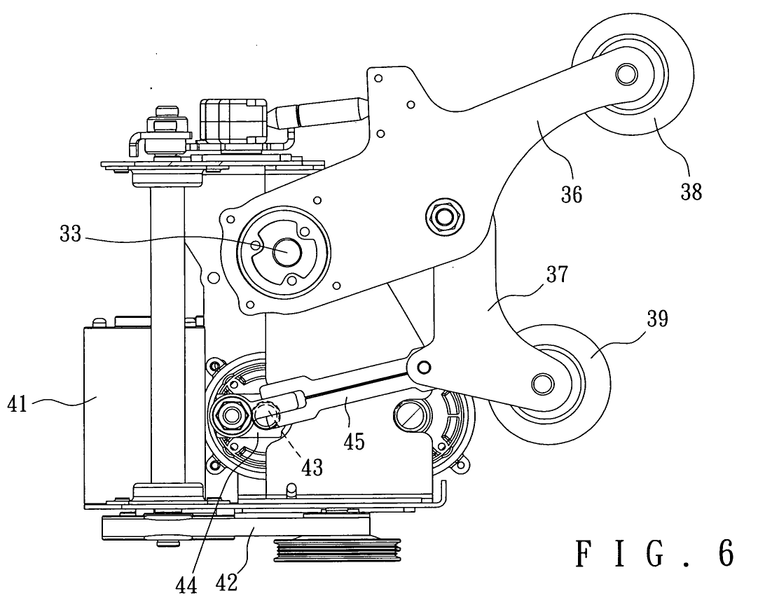

Referring to FIGS. 4-6, a kneading mechanism for use in a massage device of a massage machine in accordance with the present invention comprises a rubbing mechanism 3 and a kneading mechanism 4, the rubbing mechanism 3 includes a motor for a driver, by which a transmitting assembly 32 is driven for urging the rotation of a kneading shaft 33, the kneading shaft 33 includes an outwardly eccentric kneading sleeve 34 axially disposed at each of two ends thereof, and the kneading sleeve 34 includes a swing arm 35 mounted in the exterior thereof and having a set of upper and lower swing plates 36 and 37 pivotally coupled at the front end thereof. The upper swing plate 36 contains an upper massage roller 38 axially attached thereon, yet the lower swing plate 37 involves a lower massage roller 39 pivotally secured thereon, wherein the kneading mechanism 4 includes a motor 41 for a driver, by which a pulley set 42 is driven for urging a kneading stem 43. The kneading stem 43 includes a crank and connecting rod assembly axially provided at each of two ends thereof, a crank 44 contains a kneading stem 43 affixed thereon and pivotally connected with a connecting rod 45. The connecting rod 45 includes the lower swing plate 37 pivotally coupled thereon and having the lower massage roller 39 for actuating the operation of the lower swing plate 37.

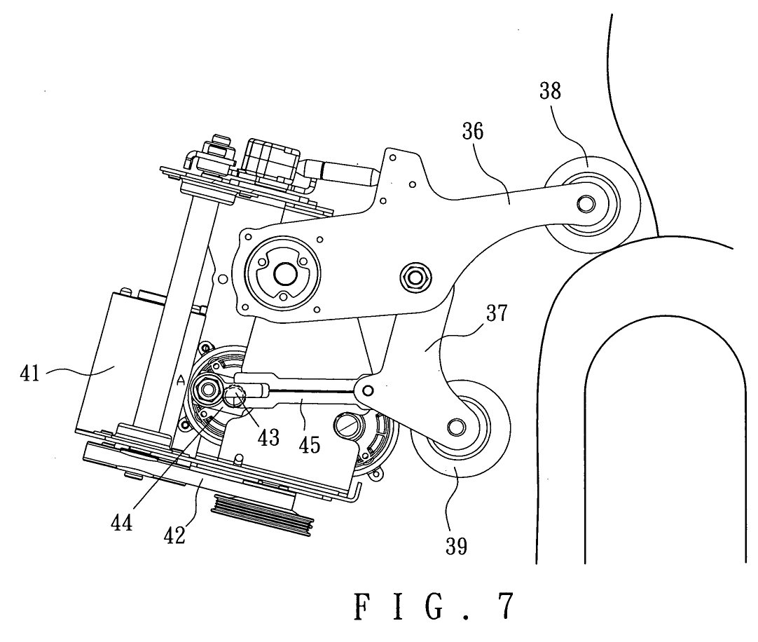

As shown in FIG. 7, during kneading operation, the massage device may controllably actuate the upper massage roller 38 to place onto user's shoulder, the kneading mechanism 4 drives the pullet set 42 by way of the motor 41, and the pulley set 42 actuates the kneading stem 43 to rotate the crank 44 clockwise. Since the crank 44 is located at an initial point A and may drive the connecting rod 45 to be located at the rearmost position, and the connecting rod 45 may also actuate the lower swing plate 37 to swing at the lowermost position, hence the lower massage roller 39 of the lower swing plate 37 may swing at the first angle and space the largest distance apart from the upper massage roller 38.

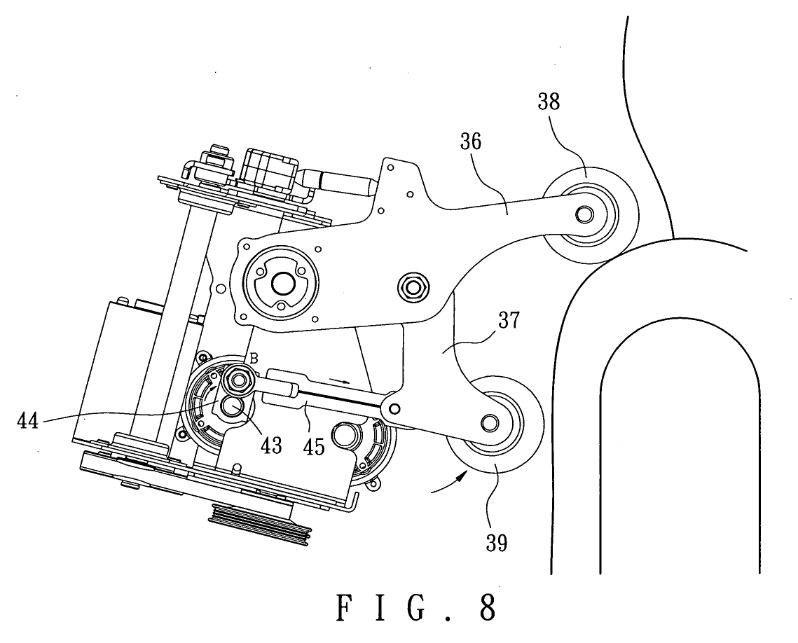

With reference to FIG. 8, while the kneading stem 43 actuates the crank 44 to swing from the point A toward a point B, the crank 44 may actuate the connecting rod 45 to displace forward so as to urge the lower swing plate 37 to swing upwardly, and the lower swing plate 37 actuates the lower massage roller 39 to displace upwardly so that the lower massage roller 39 swings at the second angle and quickly changes the distance between the upper and lower massage rollers 38 and 39.

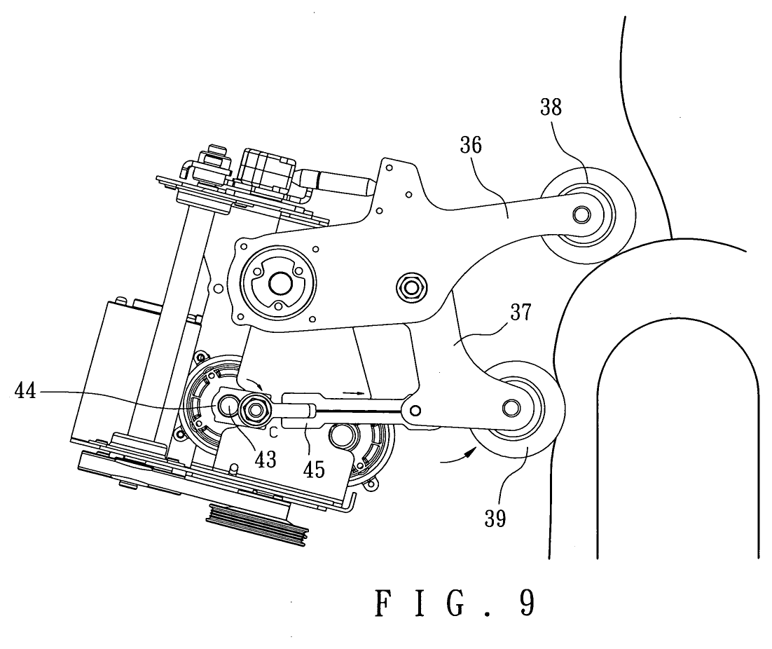

Referring to FIG. 9, while the kneading stem 43 actuates the crank 44 to swing from the point B to a point C, the crank 44 actuates the connecting rod 45 to further displace forward, such that the connecting rod 45 urges the lower swing plate 37 to swing upwardly for actuating the massage roller 39 to displace upwardly toward the highest position, and the lower massage roller 39 is located at a third angle, therefore the lower massage roller 39 presses user's shoulder associated with the upper massage roller 38. Thereby, the upper and lower massage rollers 38, 39 knead user's shoulder and quickly keep on changing the distance between the upper and lower massage roller 38 and 39.

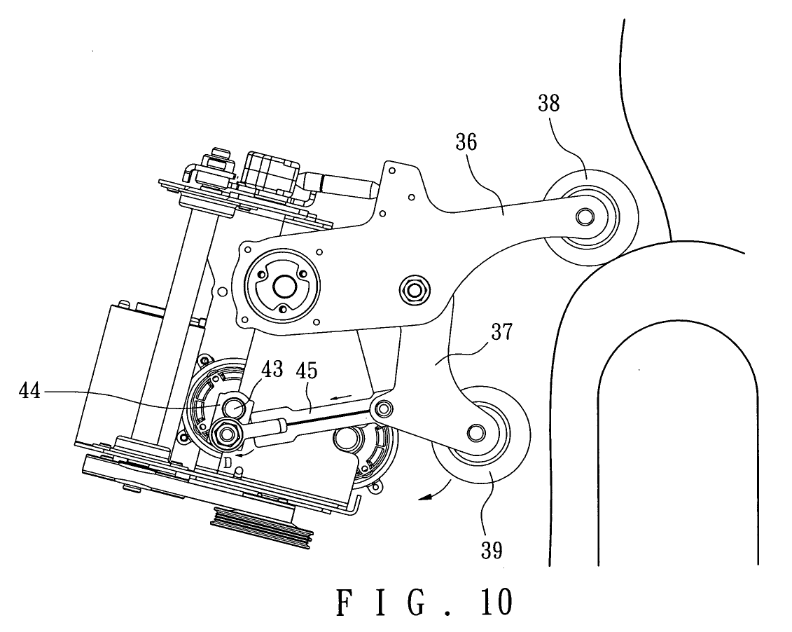

Referring to FIGS. 7 and 10, as the kneading stem 43 actuates the crank 44 to swing from the point C toward a point D, the crank 44 actuates the connecting rod 45 to displace rearward so as to actuate the lower swing plate 37 to swing downward, hence the lower swing plate 37 actuates the lower massage roller 39 to displace downward so that the lower massage roller 39 swings at the fourth angle, eases the muscle of user's shoulder, and quickly changes the distance between the upper and lower massage rollers 38 and 39, and then the kneading stem 43 actuates the crank 44 to swing upwardly from the point D toward the point A for actuating the connecting rod 45 to displace rearward, accordingly the connecting rod 45 actuates the lower swing plate 37 to swing downwardly for returning, and the kneading stem 43 may utilize the crank 44 and the connecting rod 45 to actuate the circular operation of the massage roller 39, thereby facilitating the kneading massage of user's shoulder.

As shown in FIGS. 4, 7-10, the kneading stem 43 may cooperate with the crank 44 and the connecting rod 45 to quickly actuate the operation of the lower swing plate 37 and the lower massage roller 39, thereby the lower massage roller 39 not only can knead user's shoulder but also can changeably swing form the first angle position toward the fourth angle position so as to adjust the distance between the upper and lower massage rollers 38 and 39, and while the kneading mechanism 3 actuates the upper and lower massage rollers 38 and 39 to have a rubbing massage, the rubbing position of the lower massage roller 39 may obtain different massage positions and forces.

The invention is not limited to the above embodiment but various modifications thereof may be made. It will be understood by those skilled in the art that various changes in form and detail may made without departing from the scope and spirit of the present invention.

What is claimed is:

1. A kneading mechanism for use in a massage device of a massage machine comprising:
two sets of upper and lower swing plates having upper and lower massage rollers, a kneading mechanism for actuating said lower massage roller to have a kneading massage, wherein
said kneading mechanism drives a kneading stem by using a driver, said kneading stem includes a crank and connecting rod assembly axially disposed at each of two ends thereof, and a connecting rod of the crank and connecting rod assembly is axially coupled onto each of said lower swing plate such that said lower swing plate may be easily controlled to actuate the operation and multiple-section position of said lower massage roller.

2. The kneading mechanism for use in a massage device of a massage machine as claimed in claim 1, wherein the driver of said kneading mechanism is a motor, by which a pulley set is driven and used to actuate said kneading stem.

3. The kneading mechanism for use in a massage device of a massage machine as claimed in claim 1, wherein a crank of the crank and connecting rod assembly is axially affixed on said kneading stem, and said connecting rod is pivotally connected onto said lower swing plate.
